(19) United States
(12) Patent Application Publication
(10) Pub. No.: US 2002/0165708 A1
(43) Pub. Date: Nov. 7, 2002

(54) Method and system for translating human language text

(75) Inventor: David B. Kumhyr, Austin, TX (US)

Correspondence Address: Frank C. Nicholas, CARDINAL LAW GROUP, Suite 2000, 1603 Orrington Avenue, Evanton, IL, 60201, US

(73) Assignee: International Business Machines Corporation, Armonk, NY (US)

(21) Appl. No.: 09/848,174

(22) Filed: May 3, 2001

(51) Int. Cl. G06F 17/28

(52) U.S. Cl. 704/8

(57) ABSTRACT

A machine translating computer for implementing a method for facilitating a translation of human language text from a source language to a target language is disclosed. The computer parses the human language text to generate an interlingua. In response to corrective inputs, the computer corrects any inaccuracies of the interlingua. The corrected interlingua can be parsed to generate the human language text in one or more target language forms with the human language text being stored within a computer readable medium whereby the human language text can be retrieved as needed during an execution of a program. The corrected interlingua can also be stored within a computer readable medium for parsing during an execution a program to thereby dynamically generate the human language text in target language form.

### BACKGROUND OF THE INVENTION

1. Field of the Invention

The present invention generally relates to the translation of human language text from a source language to a target language. The present invention specifically relates to the generation, modification and storage of interlingua.

2. Description of the Related Art

Machine translation systems known in the art typically include a front end parser for generating interlingua from human language text in a source language and several back end parsers for generating the human language text in various target languages from the interlingua. For example, referring to FIG. 1A, a front end parser 31 receives a human language text HLT_{E} in English and in response thereto generates an interlingua INT₁. A back end parser 40 receives interlingua INT₁ and in response thereto generates human language text HLT_{F} in French. A back end parser 41 receives interlingua INT₁ and in response thereto generates human language text HLT_{S} in Spanish. A back end parser 42 receives interlingua INT₁ and in response thereto generates human language text HLT_{I} in Italian. A back end parser 43 receives interlingua INT₁ and in response thereto generates human language text HLT_{R} in Russian. A back end parser 44 receives interlingua INT₁ and in response thereto generates human language text HLT_{J} in Japanese.

The prior art machine translations systems are notorious for stilted translations as well as incorrect translations. Consequently, translators are employed to correct any inaccuracies within the human language text in target language forms. For example, still referring to FIG. 1A, a French translator, a Spanish translator, an Italian translator, a Russian translator, and a Japanese translator are employed to correct any inaccurate translation of human language text HLT_{E} into human language text HLT_{F}, human language text HLT_{S}, human language text HLT_{I}, human language text HLT_{R}, and human language text HLT_{J}, respectively. The translators normally accomplish their task by a comparing human language text HLT_{E} to human language text HLT_{F}, human language text HLT_{S}, human language text HLT_{I}, human language text HLT_{R}, and human language text HLT_{J}.

Upon a correction of the translated human language text, files of human language text in source language form and target language forms are filed with an associated executable program. For example, referring to FIG. 1B, files of human language text HLT_{E}, human language text HLT_{F}, human language text HLT_{S}, human language text HLT_{I}, human language text HLT_{R}, and human language text HLT_{J} are shown as being stored within an executable program 50. Thus, whenever the executable program is being run by a computer, appropriate portions of the human language text from a file corresponding to a desired language of a viewer can be displayed as needed.

One disadvantage of the aforementioned process of translating human language text from a source language to several target languages is the expense and complexity in employing multiple translators. Another disadvantage is the amount of space required to file the translated human language text within a program can be excessive relative to the remaining portions of the program. Thus, until the present invention, a simple and straightforward method for translating human language text from a source language to several target languages without burdening file space for a program was not available.

### SUMMARY OF THE INVENTION

The present invention relates to a method and a system for translating human language text that overcomes the disadvantages associated with the prior art. Various aspects of the invention are novel, non-obvious, and provide various advantages. While the actual nature of the present invention covered herein can only be determined with reference to the claims appended hereto, certain features, which are characteristic of the embodiments disclosed herein, are described briefly as follows.

One form of the present invention is a method for facilitating a translation of human language text from a source language to a target language. First, an interlingua is generated as a semantic representation of the human language text in source language form. Second, any inaccuracies of the interlingua are corrected.

A second form of the present invention is a method for generating human language text during an execution of a program. First, interlingua is retrieved from a computer readable medium during the execution of the program. Second, the human language text in target language form is generated from the interlingua.

A third form of the present invention is an information handling system for facilitating a translation of human language text from a source language to a target language. The system comprises means for generating an interlingua as a semantic representation of the human language text in source language form. The system further comprises means for correcting any inaccuracies of the interlingua.

A fourth form of the present invention is a computer program product in a computer readable medium facilitating a translation of human language text from a source language to a target language. The computer program product comprises computer readable code for generating an interlingua as a semantic representation of the human language text in source language form. The computer program product further comprises computer readable code for correcting any inaccuracies of the interlingua.

The foregoing forms and other forms, features and advantages of the present invention will become further apparent from the following detailed description of the presently preferred embodiments, read in conjunction with the accompanying drawings. The detailed description and drawings are merely illustrative of the invention rather than limiting, the scope of the invention being defined by the appended claims and equivalents thereof.

### BRIEF DESCRIPTION OF THE DRAWINGS

FIG. 1A is a block diagram of machine translation software known in the art;

FIG. 1B is a block diagram of a storage of human language text within a program as known in the art;

FIG. 2 is a block diagram of one embodiment of a machine translating computer hardware employed in the present invention;

FIG. 3 is a block diagram of one embodiment of a machine translating computer software employed in the present invention;

FIG. 4 is a flow chart of one embodiment in accordance with the present invention of an interlingua routine implemented by the FIG. 3 machine translating computer software;

FIG. 5A is a block diagram of a storage of files of human language text within a program in accordance with the present invention;

FIG. 5B is a flow chart of one embodiment in accordance with the present invention of a static translation routine implemented during the FIG. 5A storage of human language text files;

FIG. 6A is a block diagram of a dynamic generation of translated human language text within a program in accordance with the present invention; and

FIG. 6B is a flow chart of one embodiment in accordance with the present invention of a dynamic translation routine implemented during the FIG. 6B generation of translated human language text.

### DETAILED DESCRIPTION OF THE PRESENTLY PREFERRED EMBODIMENTS

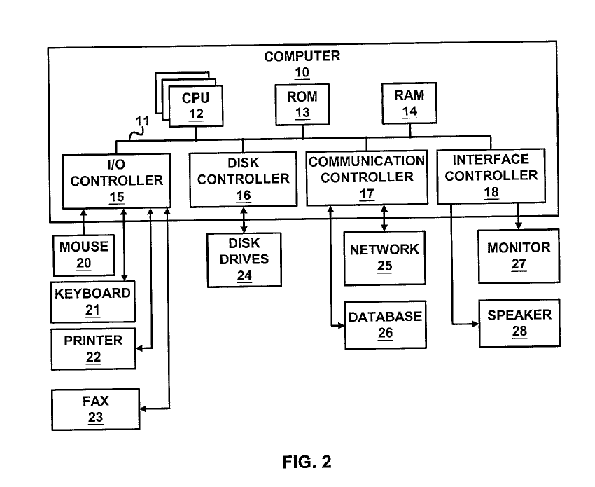

A machine translation (MT) computer 10 of the present invention is shown in FIG. 2. Referring to FIG. 2, MT computer 10 may be configured in any form for accepting structured inputs, processing the inputs in accordance with prescribed rules, and outputting the processing results as would occur to those having ordinary skill in the art, such as, for example, a personal computer, a workstation, a super computer, a mainframe computer, a minicomputer, a super minicomputer, and a microcomputer. Preferably, as shown, MT computer 10 includes a bus 11 for facilitating electrical communication among one or more central processing units (CPU) 12, a read-only memory (ROM) 13, a random access memory (RAM) 14, an input/output (I/O) controller 15, a disk controller 16, a communication controller 17, and a user interface controller 18.

CPU 12 is preferably one of the Intel families of microprocessors, one of the AMD families of microprocessors, one of the Motorola families of microprocessors, or one of the various versions of a Reduced Instruction Set Computer microprocessor such as the PowerPC chip manufactured by International Business Machine Corporation (IBM). ROM 13 stores various controlling programs such as the Basic Input-Output System (BIOS) developed by IBM. RAM 14 is the memory for loading an operating system and selectively loading controlling and application programs.

Controller 15 is an aggregate of controllers for facilitating an interaction between CPU 12 and pointing devices such as a mouse 20 and a keyboard 21, and between CPU 12 and output devices such as a printer 22 and a fax 23. Controller 16 is an aggregate of controllers for facilitating an interaction between CPU 12 and data storage devices such as disks drives 24 in the form of a hard drive, a floppy drive, a local drive, and a compact-disc drive. The hard drive of disk drives 24 stores a conventional operating system, such as an AIX operating system or an OS/2 operating system by IBM. Controller 17 is an aggregate of controllers for facilitating an interaction between CPU 12 and a network 25, and between CPU 12 and a database 26. Controller 18 is an aggregate of controllers for facilitating an interaction between CPU 12 and a graphic display device such as a monitor 27, and between CPU 12 and an audio device such as a speaker 26.

Those having skill in the art will appreciate alternative computer hardware embodiments of MT computer 10 for implementing the principles of the present invention.

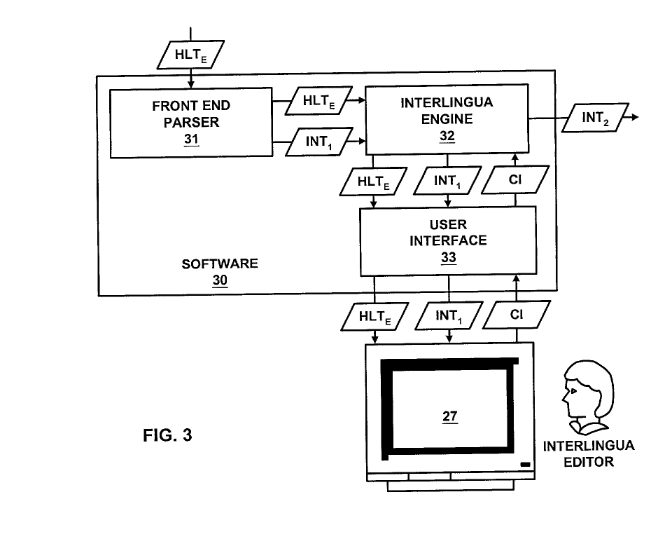

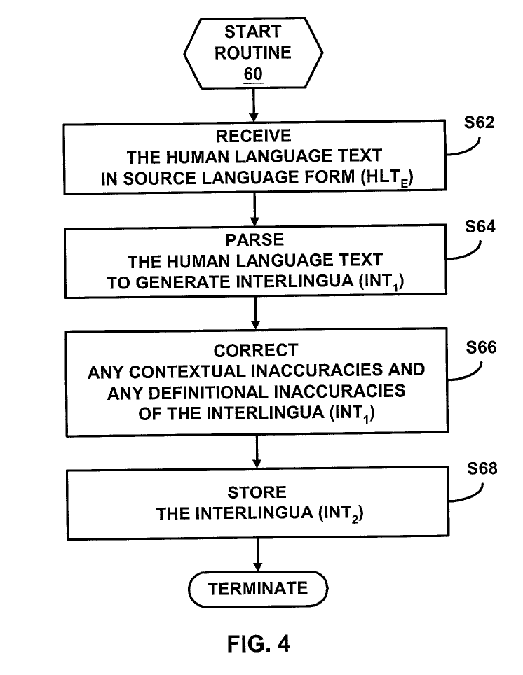

Referring additionally to FIG. 3, MT computer 10 includes an interlingua software 30 for implementing an interlingua routine 60 shown in FIG. 4. Software 30 is a computer program physically stored within the hard drive of disk drives 24 whereby the hard drive is a computer readable medium that is electrically, magnetically, optically, or chemically altered to store computer readable code. In other embodiments of MT computer 10, software 30 can be stored in other computer readable mediums of MT computer 10, such as the CD-ROM drive of disk drives 24, or software 40 can be downloaded to MT computer 10 via network 25. Also in other embodiments of MT computer 10, software 30 can be partially or fully implemented with digital circuitry, analog circuitry, or both.

Software 30 includes a front end parser 31, an interlingua engine 32, and a user interface 33. Software 30 will now be described herein in the context of processing human language text HLT_{E}. Those having ordinary skill in the art will appreciate the applicability of software 30 to human language text in any source language.

Referring additionally to FIG. 4, during a stage S62 of routine 60, parser 31 receives human language text HLT_{E}. In one embodiment, front end parser 31 extracts human language text HLT_{E} from a database 41 of a source code system 40.

Front end parser 31 proceeds thereafter to a stage S64 of routine 60 to conventionally parse human language text HLT_{E} to thereby generate interlingua INT₁. Interlingua INT₁ is ideally an unambiguous semantic representation of human language text HLT_{E} whereby human language text HLT_{E} can be easily translated from English to any target language. More often than not, front end parser 31 generates interlingua INT₁ as an ambiguous semantic representation of human language text HLT_{E} that includes one or more inaccuracies.

Accordingly, during a stage S66 of routine 60, interlingua engine 32 corrects any inaccuracies in the semantic representation of human language text HLT_{E} by interlingua INT₁. In one embodiment, interlingua engine 32 inputs human language text HLT_{E} and interlingua INT₁ as shown and controls a display of human language text HLT_{E} and interlingua INT₁ on monitor 27 via user interface 33. Consequently, an interlingua editor can view monitor 27 to compare human language text HLT_{E} and interlingua INT₁ to thereby identify any contextual inaccuracies and any definitional inaccuracies within interlingua INT₁. Alternatively or concurrently, the interlingua editor can run a back end parser (not shown) on MT computer 10 to thereby identify any contextual inaccuracies and any definitional inaccuracies within interlingua INT₁.

In response to detecting any inaccuracies, the user can utilize the pointing devices of MT computer 10 to provide one or more corrective inputs Cl to engine 32 whereby engine 32 can correct the inaccuracies to generate an interlingua INT₂ as a corrected version of interlingua INT₁. In another embodiment, engine 32 provides interlingua INT₁ to a interlingua grammar program (not shown) within MT computer 10 for comparing human language text HLT_{E} and interlingua INT₁ to thereby identify and correct inaccuracies within interlingua INT₁, or for comparing a parsing of interlingua INT₁ to human language text HLT_{E} to thereby identify and correct any inaccuracies within interlingua INT₁.

For example, human language text HLTE can include the statement “call technical support”. In response thereto, front end parser 31 can generate the following exemplary line [1] of interlingua INT₁:

(W/|desire,want|:AGENT(P/|you|):PATIENT(A/|call|:AGENT P/|technical support|NIL) [1]

To test the accuracy of line [1], the interlingua editor or the interlingua grammar program (not shown) can run a back end parser (not shown) to receive a statement that demonstrates line [1] is an accurate representation (e.g., “call technical support” or “telephone technical support”) or a statement that demonstrates line [1] is an inaccurate representation (e.g., “You desired the call of you”). When receiving line [1] as an inaccurate representation, the interlingua editor or the interlingua grammar program can utilize the grammar rules employed by front end parser 31 to thereby identify and correct any inaccuracies of line [1]. For example, “PATIENT(A/|call|” can be an inaccuracy in view of the variations in defining the term “call”. The interlingua editor or the interlingua grammar program can correct this inaccuracy by replacing the term “call” with the term “telephone”. Also by example, “AGENT(P/|you|)” and “AGENT P/|technical support|” can be an inaccuracy under the grammar rules whereby “AGENT(P/Itechnical supporti)” and “AGENT P/|you|” is the correct semantic representation that can be corrected by the interlingua editor or the interlingua grammar program.

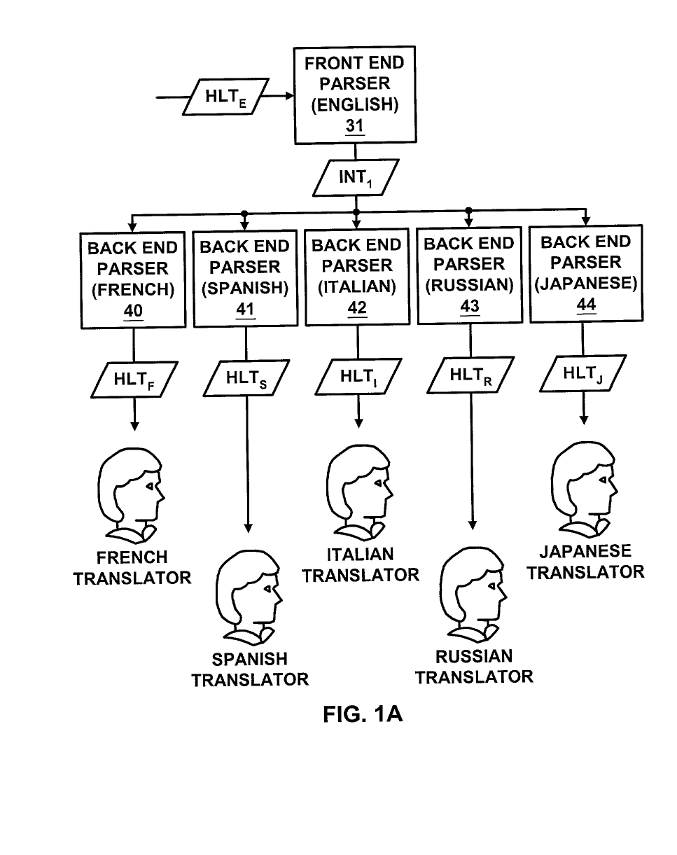

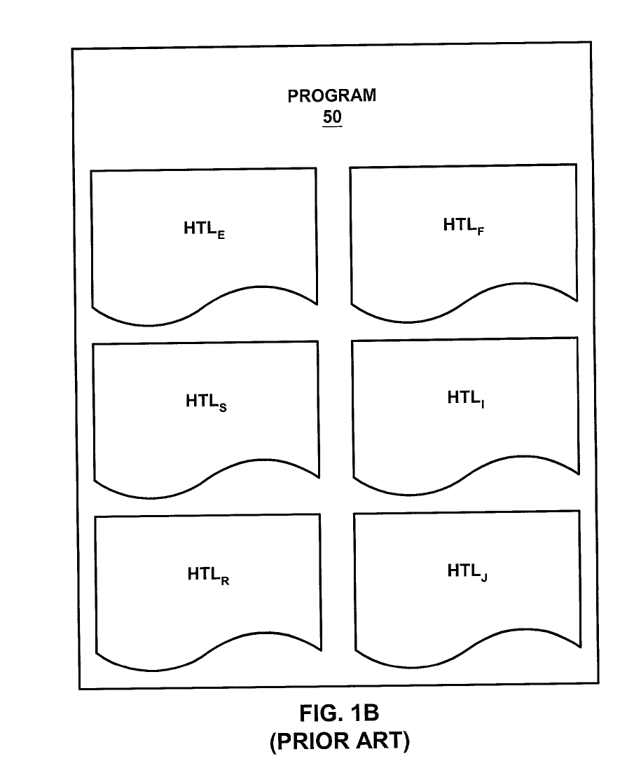

Interlingua engine 32 thereafter proceeds to a stage S68 of routine 60 to store interlingua INT₂ within one of the disk drives 24 (FIG. 2), or database 26 (FIG. 2). Those having ordinary skill in the art will appreciate the simplicity of the implementation of routine 60 by software 30 as compared to the complexity of managing multiple translators as shown in FIG. 1A. Those having ordinary skill in the art will further appreciate the benefit of being able to retrieve and edit interlingua INT₂ as needed.

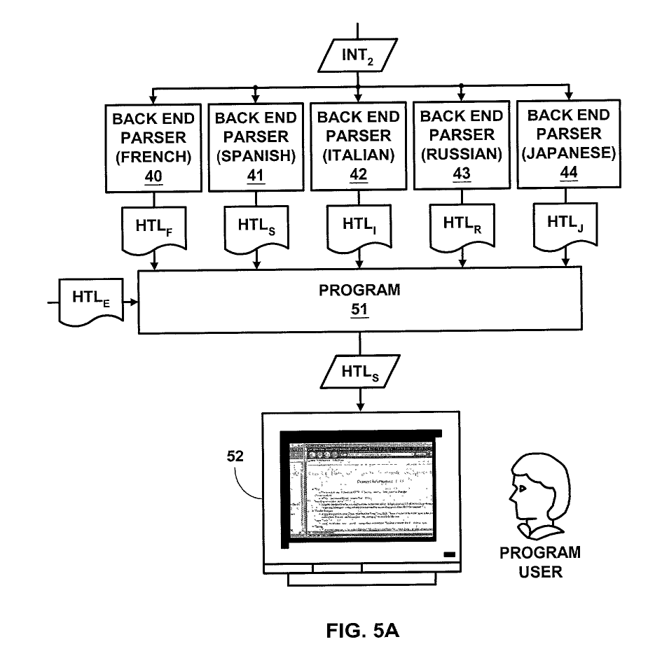

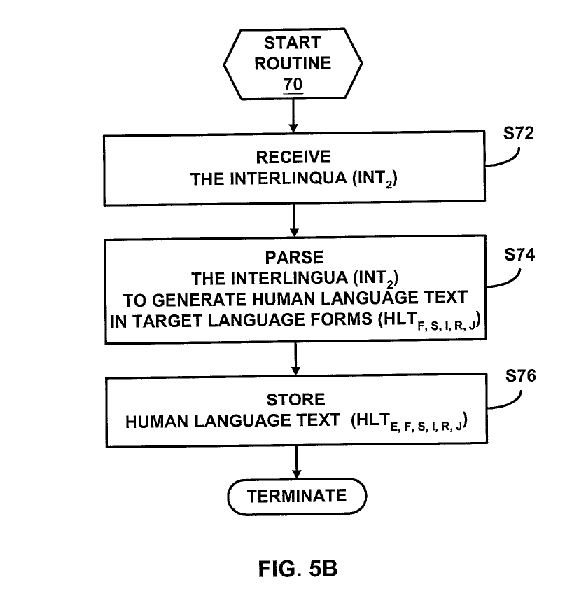

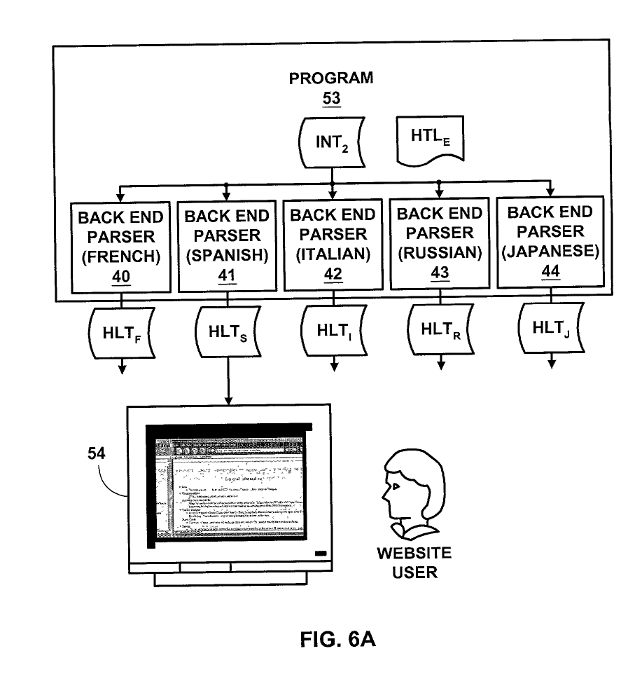

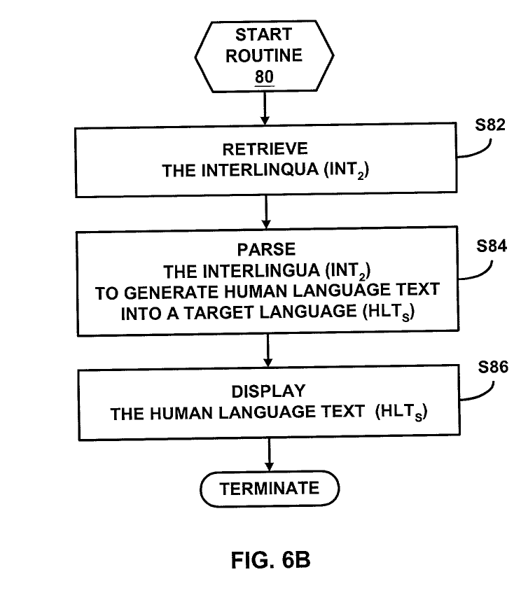

The generation of interlingua INT₂ facilitates a static translation of human language text HLT_{E} from English to one of the target languages as shown in FIGS. 5A and 5B, or a dynamic translation of human language text HLT_{E} from English to one of the target languages as shown in FIGS. 6A and 6B. A static translation and a dynamic translation of human language text HLT_{E} to human language text HLT_{F}, HLT_{S}, HLT_{I}, HLT_{R}, and HLT_{J} will now be described herein in connection with a description of FIGS. 5A and 5B, and FIGS. 6A and 6B, respectively. However, the present invention does not place any restrictions as to the range of target languages that can be derived from the human language text in a source language such as English.

Referring to FIGS. 5A and 5B, routine 70 is for the static translation of human language text HLT_{E}. During a stage S72 of routine 70, interlingua INT₂ is received by back end parsers 40-44. During a stage S74 of routine 70, back end parsers 40-44 generate human language text HLT_{F}, HLT_{S}, HLT_{I}, HLT_{R}, and HLT_{J}, respectively. During a stage S76 of routine 70, files of human language text HLT_{E}, HLT_{F}, HLT_{S}, HLT_{I}, HLT_{R}, and HLT_{J} are stored within a program 51 (e.g., an operating system and an application program). Routine 70 terminates after stage S76. Thereafter, whenever program 51 is executed, a program user will be able to conventionally set that language for the human language text. As a result, text from an appropriate file of human language text is retrieved and displayed such as, for example, a retrieval and display of text from the file of human language text HLT_{S} on a monitor 52 as exemplary shown in FIG. 5A.

Those having ordinary skill in the art will appreciate that routine 70 is ideally suited for a source code system that is responsible for developing and packaging a program such as program 51.

Referring to FIGS. 6A and 6B, a program 53 (e.g., a website program) includes a file of interlingua INT₂, a file of human language text HLT_{E}, and back end parsers 40-44 as shown in FIG. 6A. A routine 80 as shown in FIG. 6B is implemented by program 53 during an execution of program 53 for the dynamic translation of human language text HLT_{E}. During a stage S82 of routine 80, the file of interlingua INT₂ is retrieved from a memory location. During a stage S84 of routine 40, one of the back end parsers 40-44 generates human language text HLT_{F}, HLT_{S}, HLT_{I}, HLT_{R}, and HLT_{J}, respectively, from interlingua INT₂. The active back end parser 40-44 is activated based on a desired language from a user of program 53, such as, for example, a website user as shown. During a stage S86 of routine 80, the appropriate human language text HLT_{F}, HLT_{S}, HLT_{I}, HLT_{R}, and HLT_{J} is displayed, such as, for example, on a monitor 54.

Those having ordinary skill in the art will appreciate that the collective file sizes of interlingua INT₂, human language text HLT_{E}, and back end parsers 40-44 within program 53 more often than not will not exceed the collective file sizes of human language text HLT_{F}, HLT_{S}, HLT_{I}, HLT_{R}, and HLT_{J} within program 50 as shown in FIG. 1B. And, in most cases, the collective file sizes of interlingua INT₂, human language text HLT_{E}, and back end parsers 40-44 within program 53 will be significantly less the collective file sizes of human language text HLT_{F}, HLT_{S}, HLT_{I}, HLT_{R}, and HLT_{J} within program 50.

Referring to FIGS. 2 and 3, in other embodiments of the present invention, front end parser 31 and interlingua engine 32, can by distributed among two or more computers within a distributed computer network.

While the embodiments of the present invention disclosed herein are presently considered to be preferred, various changes and modifications can be made without departing from the spirit and scope of the invention. The scope of the invention is indicated in the appended claims, and all changes that come within the meaning and range of equivalents are intended to be embraced therein.

What is claimed is:

1. A method for facilitating a translation of a human language text from a source language to a target language, said method comprising:
generating an interlingua as a semantic representation of the human language text in source language form; and
correcting any inaccuracies of the interlingua.

2. The method of claim 1, further comprising:
storing the interlingua as corrected within a computer readable medium.

3. The method of claim 2, further comprising:
storing a program requiring the human language text in target language form within the computer readable medium,
wherein the interlingua is stored as a file within the program.

4. The method of claim 1, further comprising:
executing a program requiring the human language text in target language form; and
generating the human language text in target language form from the interlingua as corrected during an execution of the program.

5. The method of claim 1, further comprising:
generating the human language text in target language form from the interlingua as corrected; and
storing the human language text in target language form in a computer readable medium.

6. A method for generating a human language text in a target language during an execution of a program, said method comprising:
retrieving an interlingua from a computer readable medium during the execution of the program; and
generating the human language text in target language form from the interlingua during the execution of the program.

7. The method of claim 6, further comprising:
storing the human language text in target language from within the computer readable medium.

8. A information handling system for facilitating a translation of a human language text from a source language to a target language, said information handling comprising:
means for generating an interlingua as a semantic representation of the human language text in source language form; and
means for correcting any inaccuracies of the interlingua.

9. The information handling system of claim 8, further comprising:
means for storing the interlingua as corrected within a computer readable medium.

10. The information handling system of claim 9, further comprising:
means for storing a program requiring the human language text in target language form within the computer readable medium.

11. The information handling system of claim 8, further comprising:
means for generating the human language text in target language form from the interlingua as corrected; and
means for storing the human language text in target language form in a computer readable medium.

12. A computer program product in a computer readable medium for facilitating a translation of a human language text from a source language to a target language, said computer program product comprising:
computer readable code for generating an interlingua as a semantic representation of the human language text in source language form; and
computer readable code for correcting any inaccuracies of the interlingua.

13. The computer program product of claim 12, further comprising:
computer readable code for generating the human language text in target language form from the interlingua as corrected.

14. A computer program product in a computer readable medium for generating a human language text in a target language during an execution of a program, said computer program product comprising:
computer readable code for retrieving an interlingua from the computer readable medium during the execution of the program; and
computer readable code for generating the human language text in target language form from the interlingua during the execution of the program.

15. The computer program product of claim 14, further comprising:
computer readable code for storing the human language text in target language form.
